(19) United States
(12) Patent Application Publication
(10) Pub. No.: US 2015/0363336 A1
(43) Pub. Date: Dec. 17, 2015

(54) MEMORY DEVICE, MEMORY SYSTEM, AND METHOD OF OPERATING MEMORY SYSTEM

(71) Applicant: SAMSUNG ELECTRONICS CO., LTD., Suwon-si (KR)

(72) Inventors: SEONG-HYEOG CHOI, Hwaseong-si (KR); Jun-Jin Kong, Yongsin-si (KR); Hong-Rak Son, Anyang-si (KR); Pil-Sang Yoon, Hwaseong-si (KR); Chang-Kyu Seol, Osan-si (KR); Jung-Soo Chung, Seoul (KR)

(21) Appl. No.: 14/725,542

(22) Filed: May 29, 2015

(30) Foreign Application Priority Data
Jun. 13, 2014 (KR) 10-2014-0072296

(51) Int. Cl. G06F 12/14; G06F 11/10; G06F 3/06; G06F 21/44

(52) U.S. Cl. CPC G06F 12/1416; G06F 21/44; G06F 11/1008; G06F 3/0619; G06F 3/062; G06F 3/064; G06F 3/0637; G06F 3/0688; G06F 2212/1052

(57) ABSTRACT

A method of operating a memory system including a first function block and a second function block includes generating a first authentication response indicating physical characteristics of the memory system, via the second function block, in response to a first authentication request received from the first function block; performing an error correction decoding on the first authentication response, via the first function block, by using first parity data corresponding to the first authentication request; and determining whether the second function block is authentic, depending on a result of the error correction decoding.

### CROSS-REFERENCE TO RELATED APPLICATIONS

This application claims the benefit of Korean Patent Application No. 10-2014-0072296, filed on Jun. 13, 2014, in the Korean Intellectual Property Office, the disclosure of which is incorporated by reference in its entirety herein.

### BACKGROUND

(a) Technical Field

The inventive concept relates to a memory device, a memory system, and a method of operating the memory system, and more particularly, to a memory device and a memory system in which a security function can be performed, and a method of operating the memory system.

(b) Discussion of Related Art

With the development of the Internet and networks, the security in devices is important. In particular, as personal information and money transactions are frequently used through the Internet and networks, it is necessary to protect an access to a memory device storing information.

### SUMMARY

At least one embodiment of the inventive concept provides a memory device and a memory system in which a security function is performed, and a method of operating the memory system.

According to an exemplary embodiment of the inventive concept, there is provided a method of operating a memory system including a first function block and a second function block, the method including: generating a first authentication response indicating physical characteristics of the memory system, via the second function block, in response to a first authentication request received from the first function block; performing an error correction decoding on the first authentication response, via the first function block, by using first parity data corresponding to the first authentication request; and determining whether the second function block is authentic, based on a result of the error correction decoding.

The first function block may be a memory controller and the second function block may be a nonvolatile memory device, and the generating of the first authentication response may include reading data from a memory cell at an address corresponding to the first authentication request after programming the memory cell at the address by applying a voltage to the memory cell at the address, and using the read data as the first authentication response.

The method may further include searching for the first parity data in a first table stored in the memory controller.

The method may further include receiving the first parity data, via the memory controller, from a source external the memory system.

In an exemplary embodiment, the nonvolatile memory device is determined to be authentic, via the memory controller, when the error correction decoding succeeds.

The method may further include generating second parity data by performing an error correction encoding on the first authentication response, and transmitting the second parity data and the first authentication response from the nonvolatile memory device to the memory controller, wherein the performing of the error correction decoding is performed after performing an error correction decoding on the first authentication response by using the second parity data.

The method may further include generating the first authentication request including at least two sub-authentication requests, wherein the generating of the first authentication response includes: generating sub-authentication responses corresponding respectively to the at least two sub-authentication requests selected from sub-authentication requests set in the memory system; and combining the sub-authentication responses corresponding respectively to the at least two sub-authentication requests to generate the first authentication response.

The number of sub-authentication requests set in the memory system may correspond to a size of a space used to store authentication data in a memory cell array of the nonvolatile memory, and a size of the sub-authentication response.

When the size of the space set so as to store the authentication data in the memory cell array is N (where N is a positive integer) and the size of the sub-authentication response is R (where R is a positive integer that is equal to or less than N), the number of authentication request-response pairs may be C where C is (N/R), and when the number of sub-authentication requests included in the first authentication request is K (where K is a positive integer), the number of authentication request-response pairs that can be used in the memory system may be the number of methods of selecting K from C.

The combining of the sub-authentication responses to generate the first authentication response may include combining the sub-authentication responses corresponding respectively to the at least two sub-authentication requests in a random sequence by using at least one selected from a pseudo random number generator (PRNG) and an advanced encryption standard (AES).

The first function block may be a nonvolatile memory device and the second function block may be a memory controller, and the generating of the first authentication response may include: searching for the first parity data corresponding to the first authentication request in a first table by using the memory controller; and transmitting the first authentication response corresponding to the first authentication request and the first parity data from the memory controller to the nonvolatile memory device.

The performing of the error correction decoding may include performing an error correction decoding on the first authentication response, via the nonvolatile memory device, by using the first parity data received from the memory controller.

In an exemplary embodiment, the memory controller is determined to be authentic, via the memory device, when the error correction decoding succeeds.

At least one of the first and second function blocks may be a NAND flash memory device.

According to an exemplary embodiment of the inventive concept, there is provided a method of operating a memory device, the method including: generating a plurality of authentication responses in response to a combined authentication request obtained by combining at least two authentication requests of a plurality of authentication requests, the plurality of authentication responses indicating physical characteristics of the memory device and corresponding respectively to the plurality of authentication requests; outputting the authentication responses, which form pairs respectively with the at least two authentication requests included in the combined authentication request, as a combined authentication response for the combined authentication request; and authenticating the memory device using the output responses.

The authenticating may include performing an error decoding on the combined authentication response using parity data and determining whether the memory device is authentic based on a result of the decoding.

According to an exemplary embodiment of the inventive concept, there is provided a method of authenticating a memory. The method includes a memory controller sending a challenge to the memory, the memory controller performing an error correction decoding on a response received from the memory due to the challenge using parity data, the memory controller determining the memory to be authentic when a result of the decoding indicates a successful decoding, and the memory controller determining the memory to not be authentic when the result indicates the decoding has failed.

In an exemplary embodiment, the decoding is successful when a number of errors present in the response is less than or equal to a number of errors an error check and correction algorithm of the memory controller is capable of correcting, and the decoding fails otherwise.

Prior to the error correction decoding, the method may include using the challenge as an index into a table to retrieve the parity data.

In an exemplary embodiment, the response indicates a physical characteristic of the memory.

### BRIEF DESCRIPTION OF THE DRAWINGS

Exemplary embodiments of the inventive concept will be more clearly understood from the following detailed description taken in conjunction with the accompanying drawings in which:

FIG. 1 is a flowchart of a method of operating a memory system, according to an exemplary embodiment of the inventive concept;

FIG. 2 is a block diagram of a memory system according to an exemplary embodiment of the inventive concept;

FIG. 3 is a diagram illustrating an exemplary embodiment of the memory system of FIG. 2;

FIG. 4 is a diagram illustrating an exemplary embodiment of the memory system of FIG. 2;

FIGS. 5A and 5B are diagrams illustrating an exemplary embodiments of a cell array of a memory device in FIG. 3;

FIG. 6 is a diagram illustrating an exemplary embodiment of an authentication operation that is performed in the memory system of FIG. 3;

FIG. 7 is a diagram illustrating an exemplary embodiment of an authentication operation that is performed in the memory system of FIG. 3;

FIGS. 8 and 9 are block diagrams of exemplary embodiments of the memory system of FIG. 3;

FIG. 10 is a block diagram of a memory system according to an exemplary embodiment of the inventive concept;

FIG. 11 is a diagram illustrating a method of operating a memory system, according to an exemplary embodiment of the inventive concept;

FIG. 12 is a block diagram of a memory system for generating an authentication request-response pair, according to an exemplary embodiment of the inventive concept;

FIG. 13 is a flowchart of a method of generating an authentication request-response pair in the memory system of FIG. 12 according to an exemplary embodiment of the inventive concept;

FIG. 14 is a diagram illustrating an exemplary embodiment of a memory device of FIG. 3;

FIG. 15 is a schematic view illustrating a memory card according to an exemplary embodiment of the inventive concept; and

FIG. 16 is a schematic view illustrating a server system including an SSD of FIG. 4 and a network system, according to an exemplary embodiment of the inventive concept.

### DETAILED DESCRIPTION

Hereinafter, the inventive concept will be described more fully with reference to the accompanying drawings, in which exemplary embodiments of the inventive concept are shown. The inventive concept may, however, be embodied in many different forms and should not be construed as being limited to the embodiments set forth herein; rather, these embodiments are provided so that this disclosure will be thorough and complete, and will fully convey the inventive concept to those skilled in the art. In the drawings, like reference numerals denote like elements, and the dimensions of structures may be exaggerated for clarity. As used herein, the singular forms “a”, “an”, and “the” are intended to include the plural forms as well, unless the context clearly indicates otherwise.

In an embodiment of the present inventive concept, a three dimensional (3D) memory array is provided. The 3D memory array is monolithically formed in one or more physical levels of arrays of memory cells having an active area disposed above a silicon substrate and circuitry associated with the operation of those memory cells, whether such associated circuitry is above or within such substrate. The term “monolithic” means that layers of each level of the array are directly deposited on the layers of each underlying level of the array.

In an embodiment of the present inventive concept, the 3D memory array includes vertical NAND strings that are vertically oriented such that at least one memory cell is located over another memory cell. The at least one memory cell may comprise a charge trap layer.

The following patent documents, which are hereby incorporated by reference, describe suitable configurations for three-dimensional memory arrays, in which the three-dimensional memory array is configured as a plurality of levels, with word lines and/or bit lines shared between levels: U.S. Pat. Nos. 7,679,133; 8,553,466; 8,654,587; 8,559,235; and U.S. Pat. Pub. No. 2011/0233648.

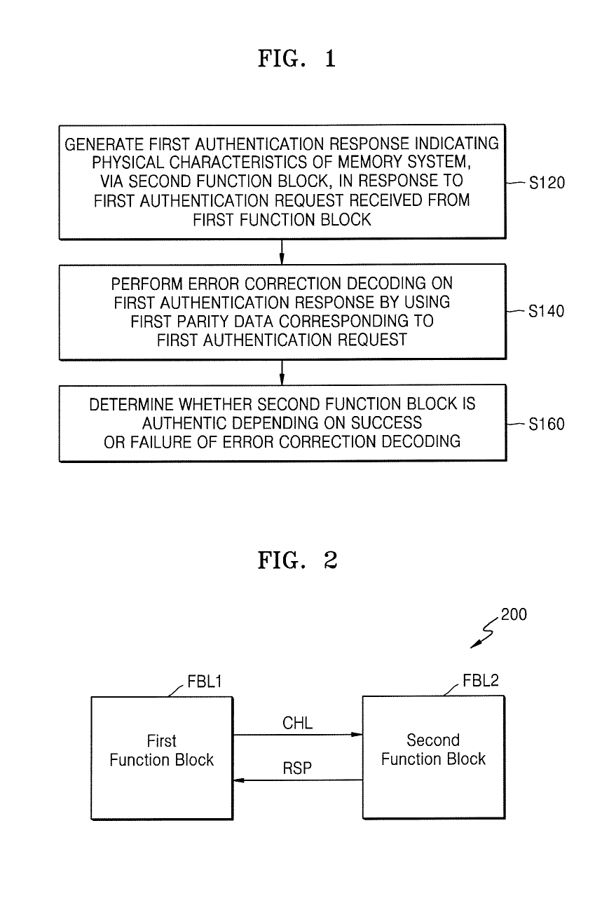

FIG. 1 is a flowchart of a method of operating a memory system 200, according to an exemplary embodiment of the inventive concept, and FIG. 2 is a block diagram of the memory system 200 according to an exemplary embodiment of the inventive concept. Referring to FIGS. 1 and 2, the method of operating the memory system 200 includes generating a first authentication response RSP indicating physical characteristics of the memory system 200, through a second function block FBL2, in response to a first authentication request CHL received from a first function block FBL1 (Operation S120), performing an error correction decoding on the first authentication response RSP by using first parity data corresponding to the first authentication request CHL (Operation S140), and determining whether the second function block FBL2 is authentic depending on the success or failure of the error correction decoding (Operation S160). In this case, the error correction decoding may be performed by using an error check and correction (ECC) algorithm.

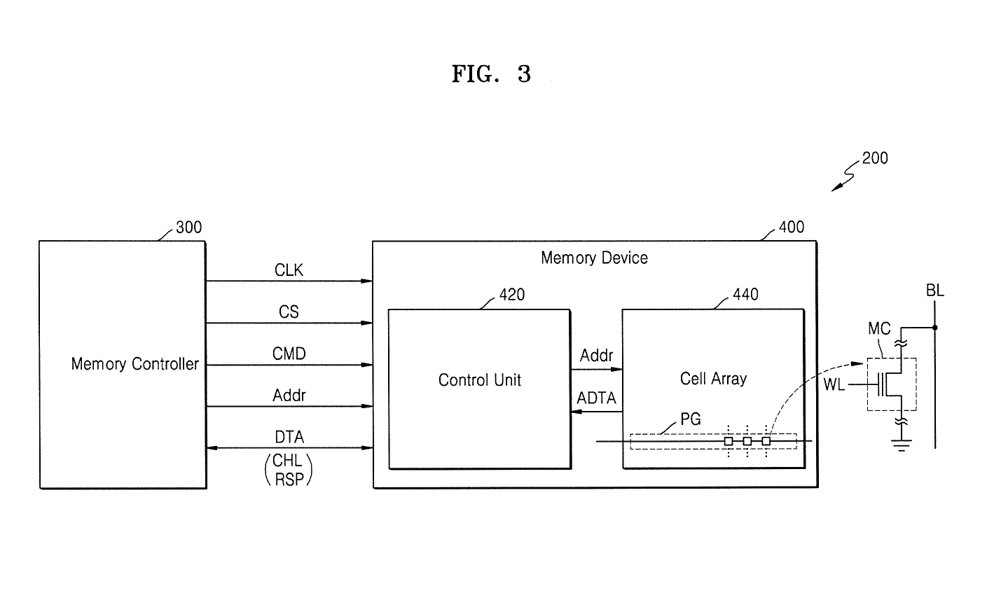

FIG. 3 is a diagram illustrating an exemplary embodiment of the memory system 200 of FIG. 2. Referring to FIG. 3, the memory system 200 includes a memory controller 300 as the first function block FBL1 and includes a memory device 400 as the second function block FBL2. The memory controller 300 provides various signals to the memory device 400 to control an operation of the memory device 400. For example, the memory controller 300 provides a clock signal CLK, a chip selection signal CS, a command CMD, and an address Addr to the memory device 400, and data DTA for write or read operations is transmitted or received between the memory controller 300 and the memory device 400.

The memory device 400 may receive the clock signal CLK, the chip selection signal CS, the command CMD, and the address Addr from the memory controller 300 and may transmit or receive the data DTA to or from the memory controller 300. The memory device 400 includes a cell array 440 and a control unit 420. The cell array 440 may include a plurality of memory cells MC and may be accessed by a word line WL and a bit line BL. The memory device 400 of FIG. 3 may be a flash memory device, e.g., a NAND flash memory device. In this case, each of the plurality of memory cells MC may include a floating gate transistor, and a plurality of memory cells MC connected to the same word line WL may be referred to as a page PG. In an exemplary embodiment, a voltage is applied to a floating gate of the floating gate transistor to charge the floating gate, which increases the threshold voltage (e.g., first threshold voltage) of the cell with no charged floating gate to a higher threshold voltage (e.g., second threshold voltage), and a value is read from the transistor by applying a read voltage between the threshold voltages to a control gate of the transistor. The difference between these threshold voltages may be referred to as threshold voltage dispersion, and due to variations in manufacturing, may vary slightly among transistors of a same type. Each memory cell MC is a memory unit of which a state may be transitioned between at least two states, and each of the at least two states may correspond to data. For example, if the memory cell is a single-level cell, two states are present (i.e., a logical 0 and a logical 1). For example, if the memory cell is a multi-level cell, more than two states are present. Also, each memory cell MC may maintain the current state thereof although power supply to the memory device 400 is blocked, and thus maintain programmed data. Hereinafter, a case in which the memory device 400 is a NAND flash memory device is described. However, the inventive concept is not limited thereto.

The control unit 420 may perform an operation on the cell array 440 according to the command CMD, the address Addr, or the data DTA, which is received from the memory controller 300, in synchronization with the clock signal CLK that is received from the memory controller 300. Also, the control unit 420 may read data stored in an Address Addr corresponding to the first authentication request CHL from the cell array 440, in response to the first authentication request CHL that is provided to the memory device 400 to perform an authentication operation to be described below. In order to perform such an operation, although not illustrated in FIG. 3, the memory device 400 may further include a decoder (not shown) for selecting a memory cell MC corresponding to the address Addr, a driver (not shown) for applying operating voltages to a word line WL and the like to perform an operation of the selected memory cell MC depending on the command CMD, a voltage generator (not shown) for generating the operating voltages, and a data input/output unit (not shown) for receiving or transmitting the data DAT.

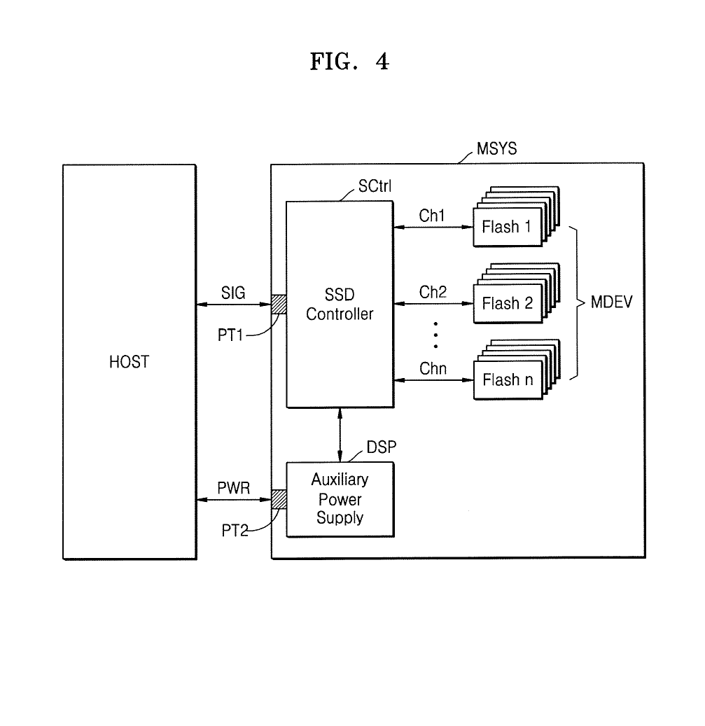

When the memory device 400 of FIG. 3 is a flash memory device, e.g., a NAND flash memory device, the memory system 200 of FIG. 3 may be exemplarily implemented as a solid state drive (SSD) MSYS, as illustrated in FIG. 4. In an exemplary embodiment, a solid state drive is a data store device that uses integrated circuit assemblies as memory to store data persistently. Referring to FIG. 4, the SSD MSYS includes an SSD controller SCtrl and at least one flash memory device MDEV. The SSD controller SCtrl controls the flash memory device MDEV in response to a signal SIG that is received from a host device HOST through a first port PT1 of the SSD MSYS. The SSD controller SCtrl may be connected to the flash memory device MDEV through a plurality of channels Ch1 to Chn. The SSD MSYS may further include an auxiliary power supply DSP to receive power PWR from the host device HOST. However, the inventive concept is not limited thereto, as the SSD MSYS may receive power from an external device other than the host device HOST. The SSD MSYS may output a result obtained by processing a request of the host device HOST through the first port PT1.

With the development of the Internet and networks, the security in devices has become increasingly important. In particular, as personal information and money transactions are frequently used through the Internet and networks, access to a memory device storing information has to be controlled. In this case, direct access to the memory device 400 or indirect access through another memory device 400 has to be controlled. For example, an attacker may directly attack a flash memory device Flash1 connected to a first channel Ch1 of FIG. 4 (case 1), and may also attack the flash memory device Flash1 through a flash memory device Flash 2 connected to a second channel Ch2 of FIG. 4 (case 2). In order to prevent case 1, in an exemplary embodiment, the memory device 400 only grants access to an authenticated memory controller 300. In order to prevent case 2, in an exemplary embodiment, the memory controller 300 performs only a control for an authenticated memory device 400 because the memory controller 300 may be copied by a non-authenticated memory device 400.

Accordingly, an authentication operation for the memory device 400 may be performed by the memory controller 300 to prevent a copy of the memory controller 300 as well as to secure information stored in the memory device 400. Furthermore, an authentication operation for the memory device 400 may be performed by the memory controller 300 to secure the quality of the memory system 200. For example, the memory controller 300 may perform an authentication for the memory device 400 to check whether the SSD controller SCtrl and the flash memory device MDEV in the SSD MSYS of FIG. 4 were manufactured by the same or mutually authenticated manufacturer. However, the inventive concept is not limited thereto, and the memory device 400 may also perform an authentication for the memory controller 300 to secure the quality of the memory system 200. That is, according to various requirements, it is required to authenticate whether the memory controller 300 has the right to access the memory device 400 or the memory device 400 has the right to access the memory controller 300. This operation is described below.

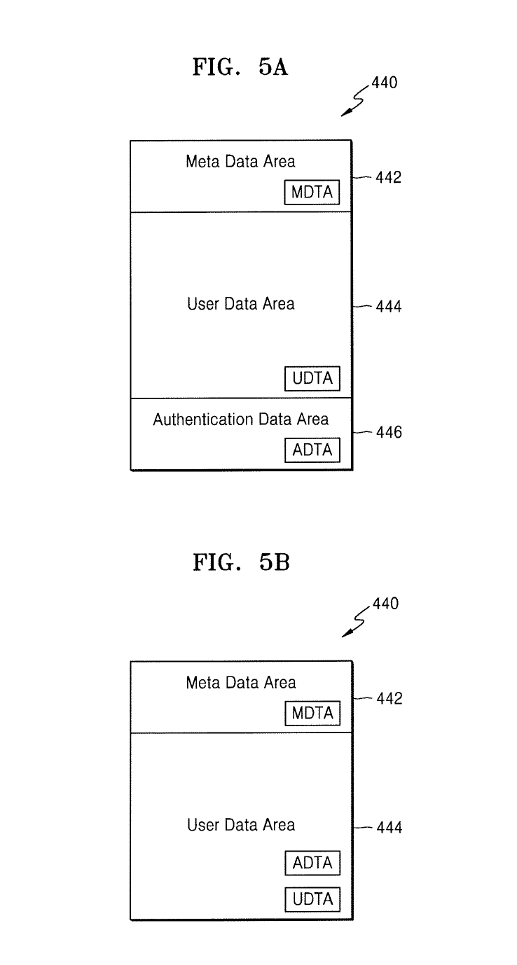

FIG. 5A is a diagram illustrating the cell array 440 of the memory device 400 of FIG. 3 according to an exemplary embodiment of the inventive concept. Referring to FIGS. 3 and 5A, the cell array 440 includes a metadata area 442, a user data area 444, and an authentication data area 446. The location and relative size of the metadata area 442, the location and relative size of the user data area 444, and the location and relative size of the authentication data area 446 are not limited to what is depicted in FIG. 5A. For example, the size of any of the data areas may be increased or decreased based on application requirements. The metadata area 442 may include metadata MDTA that is required for an operation of the memory device 400. For example, when the memory device 400 is a flash memory device, an initial read voltage level, a program/erase (P/E) cycle, information about a mapping between a log block and a data block, and the like may be stored in the metadata area 442 as the metadata MDTA. The P/E information may indicate how many P/E cycles have occurred. User data UDTA programmed according to a request of a user may be stored in the user data area 444.

Authentication data ADTA may be generated by using the authentication data area 446. The authentication data ADTA may be generated by performing a read operation, with a specific voltage, after programming a certain voltage to a memory cell. In an exemplary embodiment, a voltage for a program operation and a voltage for a read operation, which are used when generating the authentication data ADTA, are different from a voltage that is used for programming and reading the user data UDTA. The authentication data ADTA indicates physical characteristics of the memory device 400, and thus functions like an intrinsic identifier of the memory device 400. In other words, the authentication data ADTA indicates intrinsic characteristics depending on the physical deviation of a manufacturing process of the memory device 400, like human fingerprints or personal identifiers. For example, although a memory cell of an authentication data area in each of a plurality of memory devices is programmed by using the same voltage, threshold voltage distribution for the programmed memory cell is different for each memory device. Accordingly, when data of the memory cell of the authentication data area is read with any read voltage, different pieces of authentication data are read from each of the plurality of memory devices. For example, although a program operation is performed on the flash memory device Flash1 on the first channel Ch1 of FIG. 4 and the flash memory device Flash2 on the second channel Ch2 of FIG. 4 by using the same program voltage, authentication data read from the flash memory device Flash1 is different from that read from the flash memory device Flash2. For example, if Flash1 and Flash2 have different enough threshold voltage dispersions, a bit returned from a read of the same authentication data could be interpreted differently (e.g., as a 0 in a read of Flash 1 and a 1 in a read of Flash2).

The size of the authentication data ADTA may be variously set according to the extent of security, which is required by the memory device 400 or the memory system 200, and the extent of assignable resources. For example, the authentication data ADTA may have the same size as a page or a size obtained by dividing the page by N (where N is a natural number). Alternatively, the authentication data ADTA may be set to the size of a block. If the authentication data area 446 is set to a size to which one or more authentication data ADTA are stored, the authentication data area 446 may be variously set according to the extent of security, which is required by the memory device 400 or the memory system 200, and the extent of assignable resources, similar to the authentication data ADTA.

FIG. 5B is a diagram illustrating the cell array 440 of the memory device 400 of FIG. 3 according to an exemplary embodiment of the inventive concept. Referring to FIGS. 3 and 5B, the cell array 440 includes a metadata area 442 and a user data area 444. Similar to the metadata area 442 of FIG. 5A, the metadata area 442 of FIG. 5B includes metadata MDTA that is required for an operation of the memory device 400. Similarly, user data UDTA programmed according to a request of a user is stored in the user data area 444. However, a separate space for authentication data ADTA is allocated in the cell array 440 of FIG. 5B, and the authentication data ADTA is generated from the user data area 444. That is, an address corresponding to an authentication request indicates the user data area 444 or locations within the user data area 444. As described above, the authentication data ADTA may be generated through a programming for and a reading for an address corresponding thereto.

When the memory system 200 is turned on, the memory device 400 is connected to the memory controller 300, or authentication between the memory device 400 and the memory controller 300 is required and connection occurs only after an authentication operation is performed between the memory controller 300 and the memory device 400. However, when an authentication operation is performed by using the first authentication request CHL and the first authentication response RSP, the memory controller 300 or the memory device 400 has to store a challenge-response pair. In this case, the first authentication request CHL may correspond to an address at which the authentication data ADTA is generated.

Since the memory system 200 uses characteristics of the memory cells MC in this manner, the memory system 200 uses an address as an authentication request and uses data corresponding to the address as an authentication response, and thus has a difficulty in generating a model, unlike other devices. According to a memory device, a memory system, and a method of operating the memory system, according to embodiments of the inventive concept, a storage space that is required for storing a challenge-response pair may be reduced in size by performing an authentication operation by using parity data as described with reference to FIG. 1. This is described in detail below.

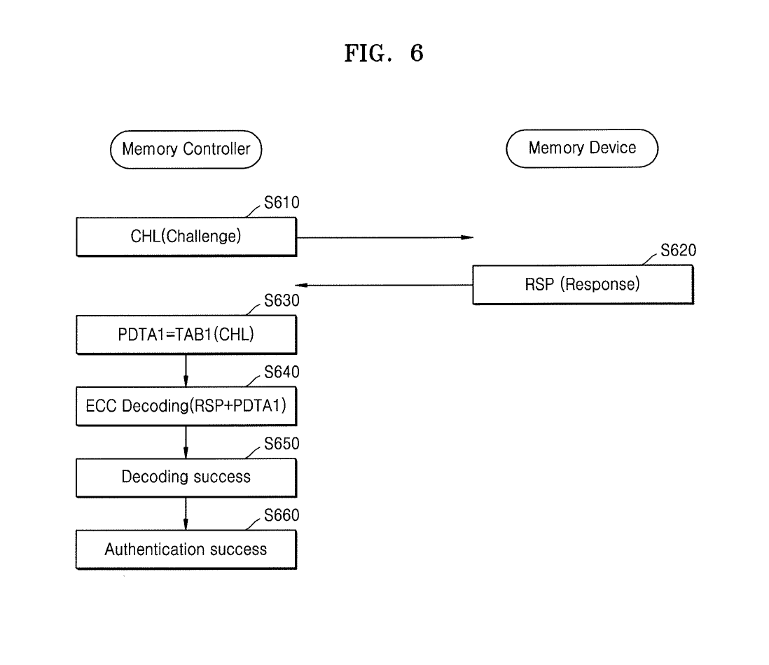

FIG. 6 is a diagram illustrating an authentication operation that is performed in the memory system 200 of FIG. 3 according to an exemplary embodiment of the inventive concept. Referring to FIGS. 1, 3, and 6, when the memory controller 300 transmits the first authentication request CHL to the memory device 400 (Operation S610), the memory device 400 uses the authentication data ADTA indicating physical characteristics of the memory cells MC as the first authentication response RSP (Operation S620), and thus, the first authentication response RSP is generated (Operation S120). For example, the memory device 400 may include a header and the like in the authentication data ADTA to thereby generate the first authentication response RSP. The header may include information, which is required for data transmission and reception between the memory device 400 and the memory controller 300, and information indicating that a certain authentication response is an authentication response for the first authentication request CHL.

The memory controller 300 that receives the first authentication response RSP searches for first parity data PDTA1 in a first table TAB1 (Operation S630). For example, the first table TAB1 may include an entry for each authentication request where each entry includes parity data. For example, the first authentication request CHL may be is used as an index into the first table TAB1 to select the entry associated with the first authentication request CHL to retrieve its contents as the first parity data PDTA1. However, the inventive concept is not limited thereto, and the memory controller 300 may receive the first parity data PDTA1 corresponding to the first authentication request CHL from an external server (not shown) when an authentication operation is required.

Next, the memory controller 300 performs an ECC decoding on the first authentication response RSP by using the first parity data PDTA1 (Operation S140 and Operation S640). The ECC decoding may be performed by using an ECC engine (not shown) included in the memory controller 300.

The memory controller 300 determines whether the ECC decoding succeeded (Operation S160 and Operation S650). For example, if the ECC engine performing the ECC decoding can correct one bit error and an error of one bit or less is included in the first authentication response RSP, it is determined that the ECC decoding succeeded (S660). On the other hand, if the ECC engine performing the ECC decoding can correct one bit error and an error of two bits or more is included in the first authentication response RSP, it is determined that the ECC decoding failed.

An error correction capability of the ECC engine may be changed depending on circumstances, such as the extent of security, which is required by the memory device 400 or the memory system 200, or resources that may be used for an authentication operation. An ECC engine that performs such an operation during the authentication operation may be prepared separately from an ECC engine that performs an error check and correction operation during a normal operation (e.g., a program operation or a read operation) other than the authentication operation. Alternatively, the ECC decoding operation for the authentication operation may be performed by using the ECC engine that performs an error check and correction operation during the normal operation.

If the ECC decoding succeeds, the memory controller 300 authenticates the memory device 400 by determining that the first authentication response RSP received from the memory device 400 is an authentication response forming a pair with the first authentication request CHL transmitted to the memory device 400 (Operation S160 and Operation S660). This determination is based on the premise that a probability that the first authentication response RSP is not an authentication response forming a pair with the first authentication request CHL is relatively high if an error, which is not correctable by an ECC engine, is included in a result obtained through an ECC decoding by using the first parity data PDTA1 mapped with respect to the first authentication request CHL.

In this manner, according to the memory device, the memory system, and the method of operating the memory system, according to the embodiments of the inventive concept, the memory controller 300 stores only parity data corresponding to an authentication response instead of an authentication request-response pair, thereby reducing required resources, reducing a layout area, and reducing power consumption.

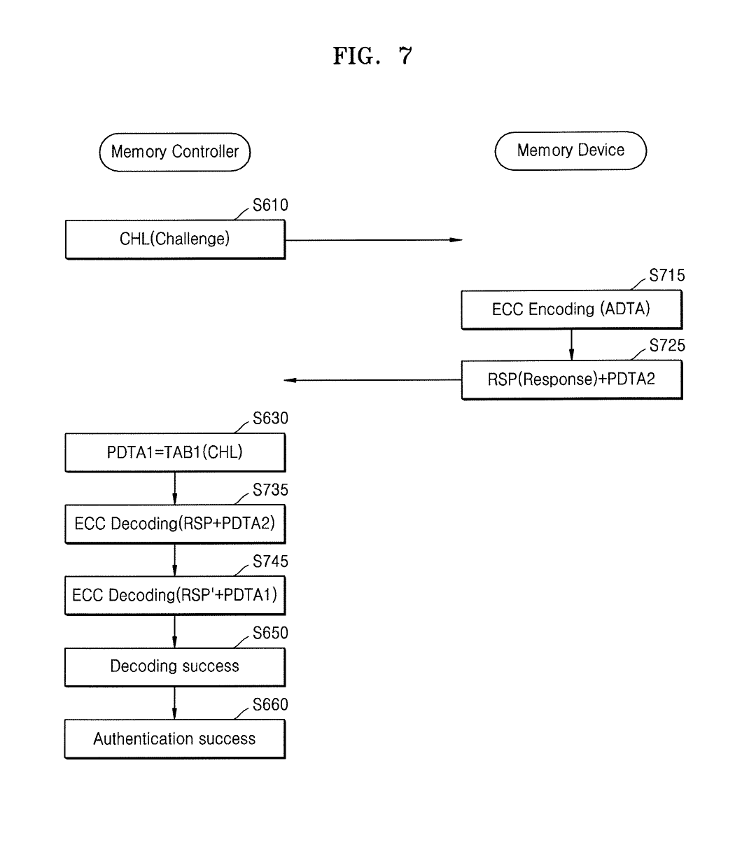

FIG. 7 is a diagram illustrating an authentication operation that is performed in the memory system 200 of FIG. 3 according to an exemplary embodiment of the inventive concept. Referring to FIGS. 1, 3, and 7, when the memory controller 300 transmits the first authentication request CHL to the memory device 400 (Operation S610), the memory device 400 uses the authentication data ADTA indicating physical characteristics of the memory cells MC as the first authentication response RSP, similar to the example of FIG. 6, and thus, the first authentication response RSP is generated (Operation S120 and Operation S725). However, in the example of FIG. 7, the memory device 400 performs an ECC encoding on authentication data ADTA to thereby generate second parity data PDTA2 (Operation S715), and transmits the second parity data PDTA2 in addition to a first authentication response RSP to the memory controller 300 or transmits a first authentication response RSP with the second parity data PDTA2 included therein to the memory controller 300 (Operation S725).

Then, the memory controller 300 searches for first parity data PDTA1 in a first table TAB1, as described with reference to FIG. 6 (Operation 5630) and performs an ECC decoding on the found first parity data PDTA1 (Operation S745). Additionally, the memory controller 300 corrects an error, which may be included in the first authentication response RSP, by using the second parity data PDTA2 (Operation S735), and then performs an ECC decoding on the error-corrected first authentication response RSP' by using the first parity data PDTA1 (Operation S745). In this case, an error of the first authentication response RSP, which may be included in the authentication data ADTA read from the memory device 400 or may be included during a data transmission between the memory controller 300 and the memory device 400, is corrected, and thus, a more reliable authentication operation may be performed.

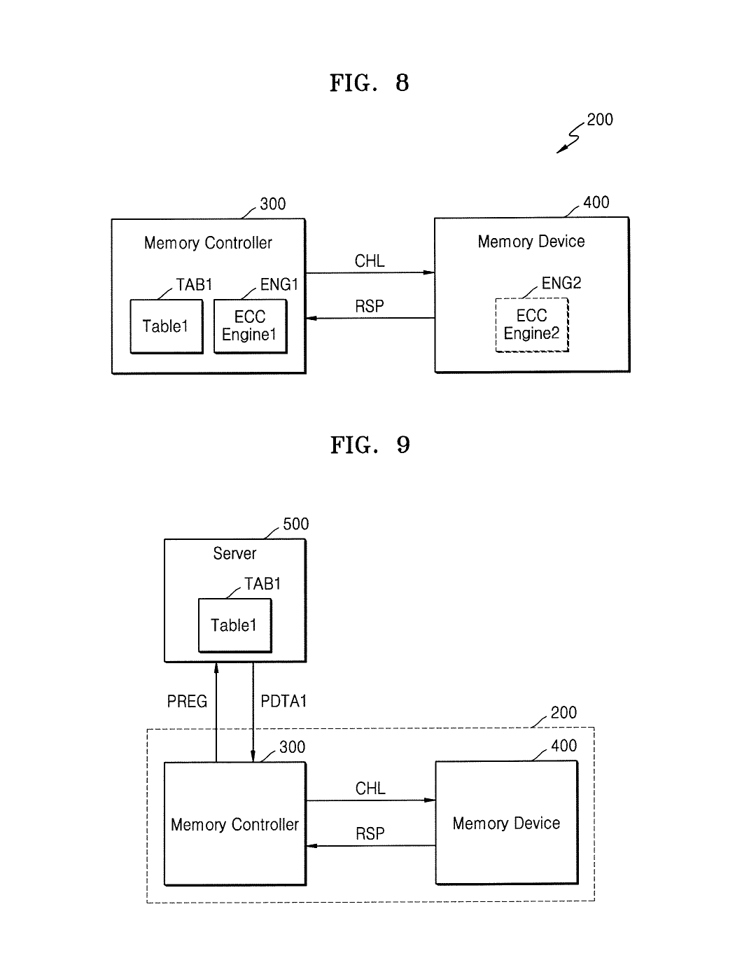

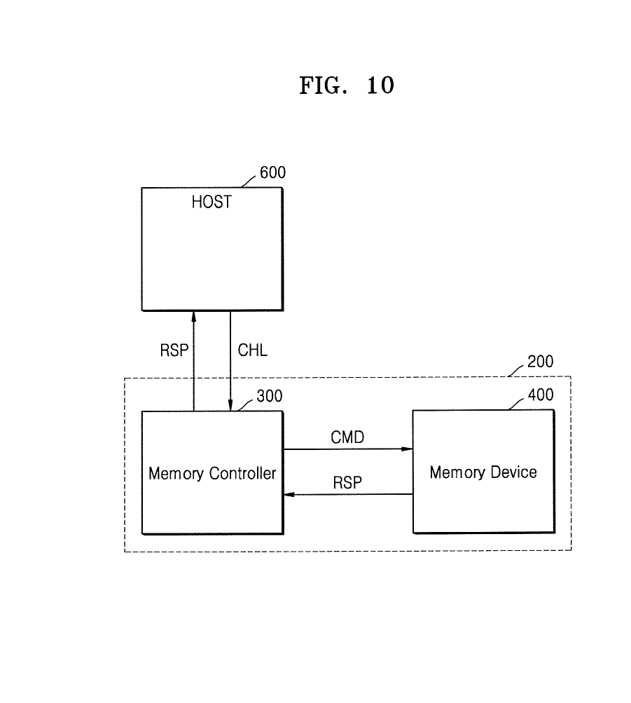

FIGS. 8 and 9 are block diagrams of examples of the memory system 200 of FIG. 3. Referring to FIG. 8, the memory controller 300 of the memory system 200 includes a first table TAB1 and a first ECC engine ENG1. In the case that the memory controller 300 receives a first authentication response RSP from the memory device 400 and then checks whether an ECC decoding succeeded (refer to Operation S650 of FIG. 6 or 7), the memory controller 300 searches for first parity data PDTA1 corresponding to the first authentication response RSP in the first table TAB1 included in the memory controller 300. For example, the first table TAB1 may be loaded from the memory device 400 into a memory of the memory controller 300, SRAM, and the like when the memory system 200 is turned on.

However, the inventive concept is not limited thereto. As illustrated in FIG. 9, the first parity data PDTA1 may be transmitted from an external server 500 to the memory controller 300. In an exemplary embodiment, the memory controller 300 sends a request PREG to the external server 500 to transmit the first parity data PDTA1 corresponding to the first authentication request CHL, and the external server 500 searches for the first parity data PDTA1 in the first table TAB1 in response to the request PREQ and then transmits the found first parity data PDTA1 to the memory controller 300. In this case, the memory system 200 saves on storage space since the first parity data PDTA1 and other parity data is stored externally.

Referring back to FIG. 8, the memory controller 300 performs an ECC decoding on the first authentication response RSP, with the found first parity data PDTA1, by using the first ECC engine ENG1 included in the memory controller 300. The memory device 400 includes a second ECC engine ENG2. The memory device 400 may perform an ECC encoding on the first authentication response RSP using the second ECC engine ENG2 and then may transmit second parity data PDTA2 in addition to a first authentication response RSP to the memory controller 300 or transmit a first authentication response RSP with the second parity data PDTA2 included therein to the memory controller 300 (Operation S725).

When the memory device 400 is authenticated through the operations described above, a normal operation (e.g., a write or read operation) of the memory device 400, may be performed. An operation in which the memory controller 300 transmits the first authentication request CHL to the memory device 400 and authenticates the memory device 400 is described above. However, the inventive concept is not limited thereto. Referring to FIG. 10 illustrating a memory system 200 according to an exemplary embodiment of the inventive concept, the authentication request CHL is applied from an external host device 600 to the memory system 200. When the memory controller 300 applies a command CMD corresponding to the first authentication request CHL, which is applied from the external host device 600, to the memory device 400, the memory device 400 generates a first authentication response RSP and transmits the generated authentication response RSP to the memory controller 300. The memory controller 300 outputs the first authentication response RSP received from the memory device 400 to the external host device 600. The external host device 600 determines whether the first authentication response RSP is an authentication response forming a pair with the first authentication request CHL, by using the method described with reference to FIG. 6, and performs an authentication operation on the memory system 200 or the memory device 400 based on the determination result.

Furthermore, in the memory system 200, an authentication operation for the memory controller 300 may be performed by the memory device 400. As described above, in order to secure product quality, it may be necessary to authenticate the memory controller 300 in the memory system 200, which is described below.

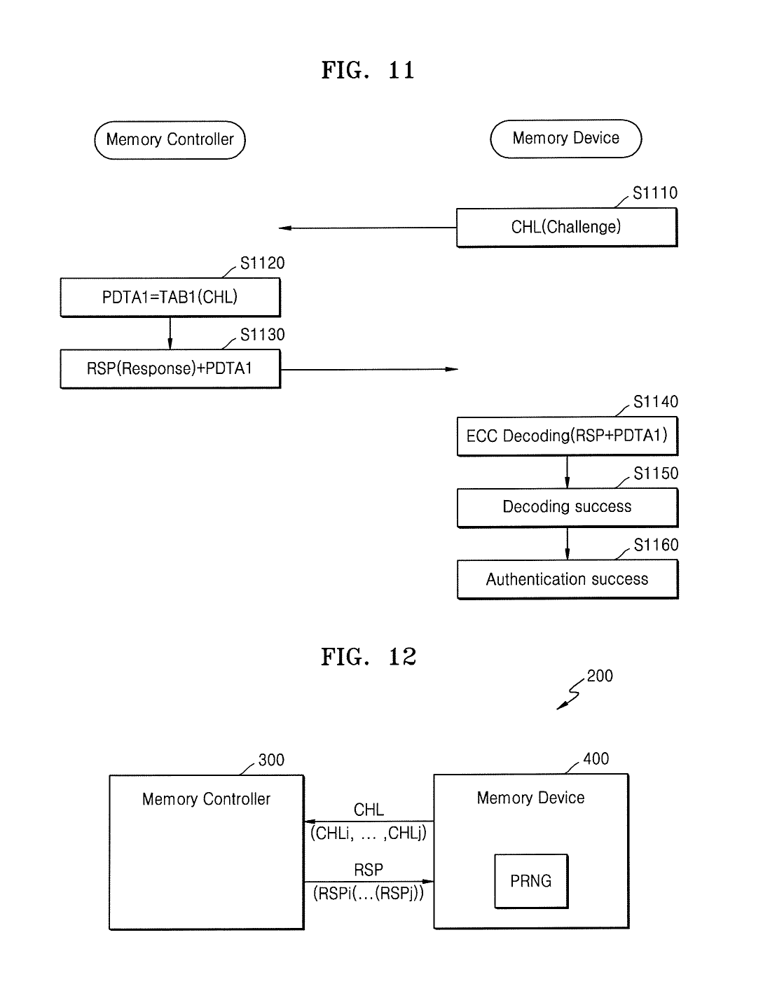

FIG. 11 is a diagram illustrating a method of operating a memory system, according to an exemplary embodiment of the inventive concept. Referring to FIGS. 2 and 11, in a memory system according to an exemplary embodiment, the first function block FBL1 is the memory device 400 and the second function block FBL2 is the memory controller 300, unlike the memory system 200 of FIG. 3. Accordingly, the memory device 400 transmits a first authentication request CHL to the memory controller 300 (Operation S1110), and the memory controller 300 transmits a first authentication response RSP corresponding to the first authentication request CHL to the memory device 400 (Operation S1130). When the first authentication request CHL is received, the memory controller 300 searches for first parity data PDTA1 corresponding to the first authentication request CHL in a first table (Operation S1120).

The memory controller 300 transmits the first parity data PDTA1 as well as the first authentication response RSP to the memory device 400 (Operation S1130). The memory device 400 receives the first authentication response RSP and the first parity data PDTA1 and performs an ECC decoding on them (Operation S1140). If the ECC decoding succeeds (Operation S1150), the memory controller 300 is authenticated (Operation S1160). Descriptions of the ECC decoding and the authentication determination are the same as those described above and thus are omitted.

The memory device 400 of FIG. 11 stores only parity data corresponding to an authentication response instead of an authentication request-response pairs by performing an authentication operation for the memory controller 300 by using the first parity data PDTA1 as described above, thereby reducing required resources, reducing a layout area, and reducing power consumption.

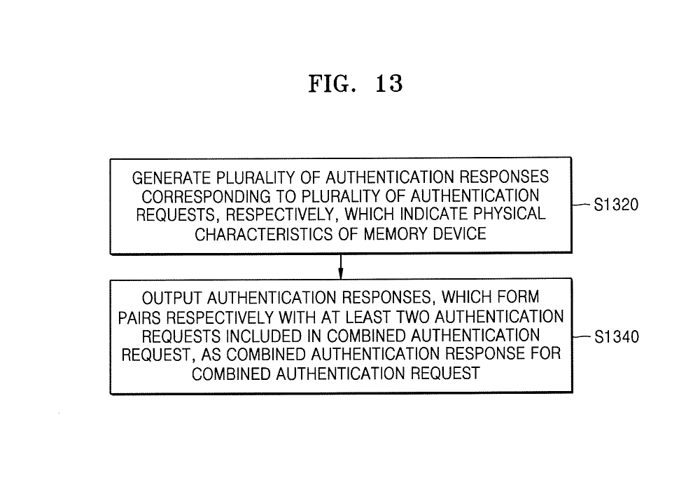

FIG. 12 is a block diagram of a memory system 200 according to an exemplary embodiment of the inventive concept, and FIG. 13 is a flowchart of a method of generating an authentication request-response pair in the memory system 200 of FIG. 12 according to an exemplary embodiment of the inventive concept. Referring to FIGS. 12 and 13, a memory device 400 of the memory system 200 generates a plurality of authentication responses RSPi, . . . , RSPj corresponding to a plurality of authentication requests CHLi, . . . , CHLj, respectively, which indicate physical characteristics of the memory device 400 and are included in the first authentication request CHL (Operation S1320). As described above, an authentication response corresponding to each of the plurality of authentication requests CHLi, . . . , CHLj may be generated by programming an address included in each of the plurality of authentication requests CHLi, . . . , CHLj, with any voltage, and then reading the programmed address, with any voltage.

The plurality of authentication requests CHLi, . . . , CHLj that may be included in the first authentication request CHL may be referred to as sub-authentication requests CHLi, . . . , CHLj. The number of sub-authentication requests that may be set with respect to the memory system 200 may be limited as described below. In addition, the first authentication request CHL in which the sub-authentication requests CHLi, . . . , CHLj are combined with each other may be referred to as a combined authentication request CHL. Likewise, the authentication responses RSPi, . . . , RSPj corresponding to the sub-authentication requests CHLi, . . . , CHLj may be referred to as sub-authentication responses RSPi, . . . , RSPj. The first authentication response RSP in which the sub-authentication responses RSPi, . . . , RSPj are combined with each other may be referred to as a combined authentication response RSP. The number of sub-authentication responses that may be set with respect to the memory system 200 may be the same as that of sub-authentication requests.

The number of sub-authentication requests that is set in the memory system 200 may correspond to a space set so as to generate authentication data ADTA in a cell array of the memory device 400, that is, the size of an authentication data area and the size of a sub-authentication response. For example, when the size of the authentication data area is N (where N is a positive integer) and the size of the sub-authentication response is R (where N is a positive integer that is equal to or less than R), the number of authentication request-response pairs is (N/R).

As described above, since the memory system 200 performs an authentication operation by using characteristics of memory cells, the memory system 200 has a difficulty in generating a model, unlike other devices. Accordingly, in the memory system 200, an address has to be used as an authentication request and data corresponding to the address has to be used as an authentication response. Together with or independently of the issue of a storage space for storing the authentication request-response pair, described above, the issue in which the number of authentication request-response pairs is limited may be caused. If the number of authentication request-response pairs, set in the memory system 200, is relatively few, an attacker may collect the authentication request-response pairs and analyze the collected request-response pairs. In this case, the reliability of the memory device or memory system may be lowered. The memory system 200 may strengthen the reliability of the memory device or memory system by generating more authentication request-response pairs by using a limited number of authentication request-response pairs.

Referring to FIGS. 12 and 13 again, when the size of the authentication data area is N and the size of the sub-authentication response is R, the number of authentication request-response pairs is C where C is (N/R). However, in a method of operating the memory system 200 according to at least one embodiment of the inventive concept, when a combined authentication request CHL is generated by combining at least two sub-authentication requests CHLi, . . . CHLj (Operation S1320) and a combined authentication response RSP is generated by combining sub-authentication responses RSPi, . . . RSPj corresponding to the sub-authentication requests CHLi, . . . CHLj, respectively (Operation S1340), the number of authentication request-response pairs set in the memory system 200 having the same resources may be increased.

FIG. 12 illustrates an example in which a combined authentication request CHL is formed by combining sub-authentication requests CHLi, . . . CHLj (where i and j are positive integers that are equal to or less than N) and a combined authentication response RSP is formed by combining sub-authentication responses RSPi, . . . RSPj corresponding to the sub-authentication requests CHLi, . . . CHLj, respectively. The combined authentication response RSP may be obtained by combining sub-authentication responses corresponding to at least two sub-authentication requests, respectively, in a random sequence by using at least one selected from a pseudo random number generator (PRNG) and an advanced encryption standard (AES).

In this case, the number of authentication request-response pairs that may be used in the memory system 200 may be increased to the number of methods of selecting K from C (where K is a positive integer). K is the number of sub-authentication requests included in an authentication request. For example, the number of authentication request-response pairs that may be used in the memory system 200 may be increased to the number of permutations _{N}P_{R} or combinations _{N}C_{R}.

In this manner, according to the memory device, the memory system, and the method of operating the memory system, according to the embodiments of the inventive concept, an authentication operation may be reliably performed also in a memory device and a memory system which have limited resources.

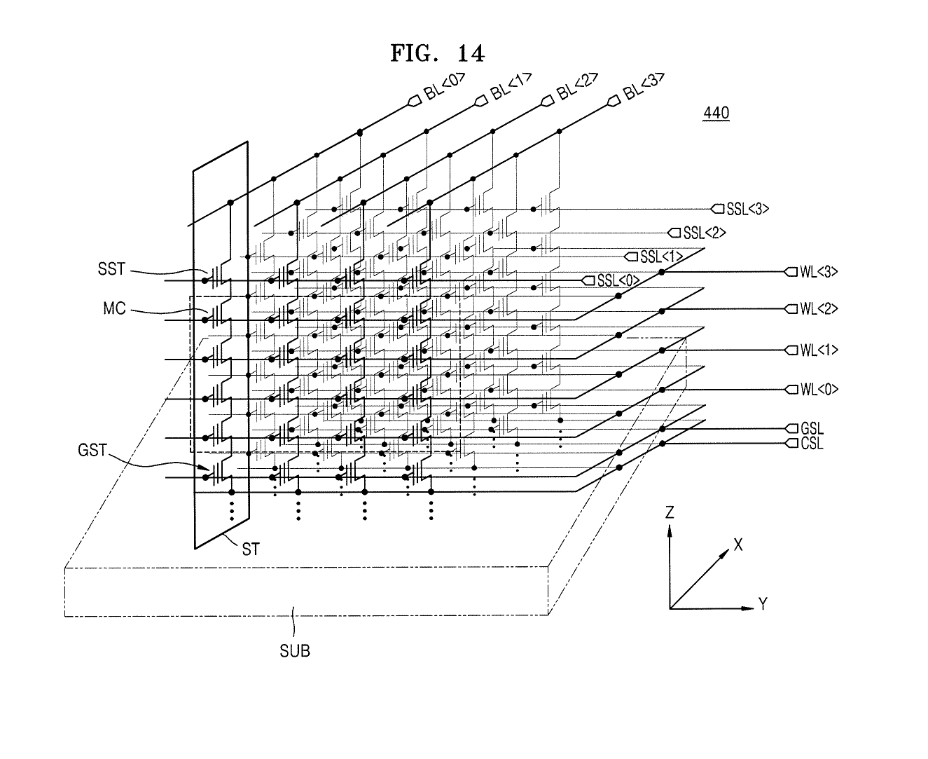

FIG. 14 is a diagram illustrating an example of the cell array 440 of FIG. 3. The cell array 440 of FIG. 3 may be a two-dimensional NAND flash memory cell array. Alternatively, the cell array 440 of FIG. 3 may be a vertical NAND flash memory cell array in which memory cells are stacked three-dimensionally, as illustrated in FIG. 14. The three-dimensional cell array 440 may include a substrate SUB, a plurality of memory cell strings ST, a plurality of word lines WL<0> to WL<3>, and a plurality of bit lines BL<0> to BL<3>. Each of the plurality of memory cell strings ST may extend in a direction (e.g., a vertical (Z-axis) direction) protruding from the substrate SUB. Each of the plurality of memory cell strings ST may include memory cells MC, a source selection transistor SST, and a ground selection transistor GST in the Z-axis direction. The source selection transistor SST may be connected to one of the source selection lines SSL<0> to SSL<3> extending in a row (Y-axis) direction, and the ground selection transistor GST may be connected to a ground selection line GSL extending in a column (X-axis) direction and the row (Y-axis) direction.

The plurality of word lines WL<0> to WL<3> are arranged in the Z-axis direction that is perpendicular to the substrate SUB. Each of the word lines WL<0> to WL<3> is positioned in a portion of a layer in which the memory cells MC in the memory cell string ST exist. The word lines WL<0> to WL<3> are combined with the memory cells MC arranged in a matrix in the X-axis and Y-axis directions on the substrate SUB. The bit lines BL<0> to BL<3> may be connected to the memory cell strings ST arranged in the X-axis direction. The memory cells MC, the source selection transistor SST, and the ground selection transistor GST, included in each of the memory cell strings ST, may share the same channel. The channel may be formed to extend in the Z-axis direction that is perpendicular to the substrate SUB.

Appropriate voltages may be applied to the word lines WL<0> to WL<3> and the bit lines BL<0> to BL<3> by the control unit 420 of FIG. 3 so that a program operation or a verification operation for the memory cells MC is performed. For example, set voltages may be applied to the source selection lines SSL<0> to SSL<3> and the bit lines BL<0> to BL<3>, connected to the source selection transistor SST, and thus, a memory cell string ST may be selected. In addition, set voltages may be applied to the word lines WL<0> to WL<3>, and thus, a memory cell MC in the selected memory cell string ST may be selected. Thus, a read operation, a program operation, and/or a verification operation for the selected memory cell MC may be performed.

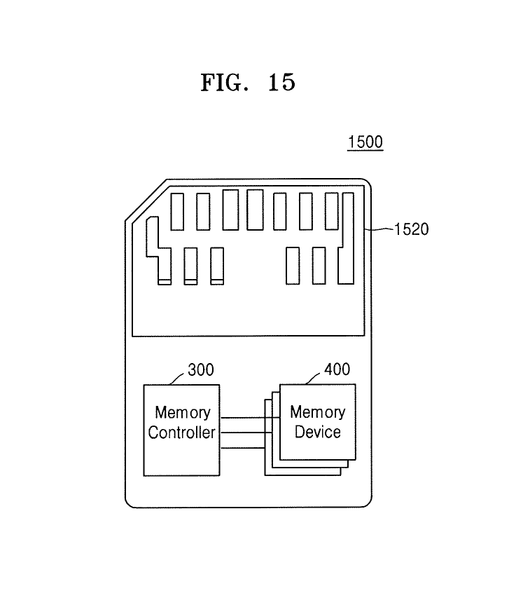

FIG. 15 is a schematic view illustrating a memory card 1500 according to an exemplary embodiment of the inventive concept. The memory card 1500 may be a portable storage device that may be connected to an electronic system such as a mobile system or a desktop computer. As illustrated in FIG. 15, the memory card 1500 includes a memory controller 300, memory devices 400, and a port region 1520. The memory card 1500 may communicate with an external host (not shown) through the port region 1520, and the memory controller 300 may control the memory devices 400. The memory controller 300 may read out a program stored in read only memory (ROM) (not shown) and may execute the read program.

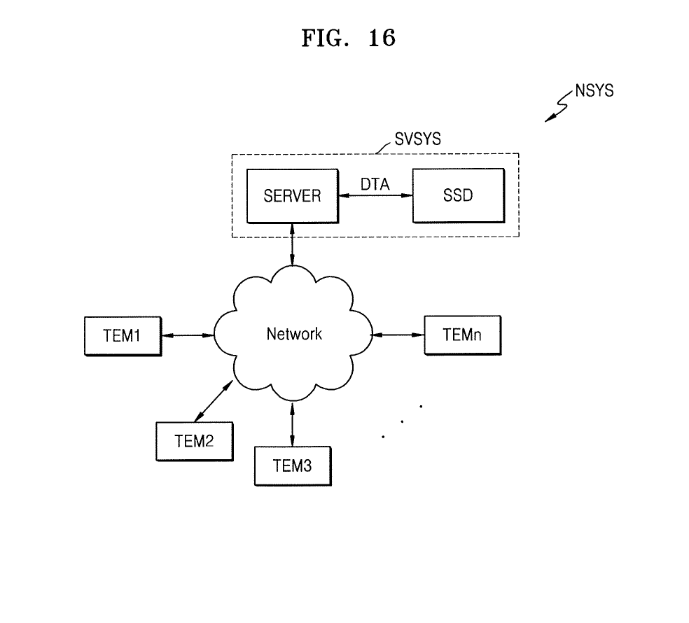

FIG. 16 is a schematic view illustrating a server system SVSYS including the SSD MSYS of FIG. 4 and a network system NSYS, according to an exemplary embodiment of the inventive concept. Referring to FIG. 16, the network system NSYS includes the server system SSYS and a plurality of terminals TEM1 to TEMn, which are connected through a network. The server system SVSYS may include a server processing requests received from the plurality of terminals TEM1 to TEMn connected to the network and an SSD storing data corresponding to the requests received from the plurality of terminals TEM1 to TEMn. Accordingly, the network system NSYS and the server system SVSYS may secure system reliability by reliably performing an authentication between a controller of the SSD and a memory of the SSD.

While the inventive concept has been particularly shown and described with reference to exemplary embodiments thereof, it will be understood that various changes in form and details may be made therein without departing from the spirit and scope of the invention. For example, although embodiments in which the above-stated memory device is a flash memory device are described above, the inventive concept is not limited thereto and may also be applied to various other nonvolatile memory devices.

What is claimed is:

1. A method of operating a memory system including a first function block and a second function block, the method comprising:
generating a first authentication response indicating a physical characteristic of the memory system, via the second function block, in response to a first authentication request received from the first function block;
performing an error correction decoding on the first authentication response, via the first function block, by using first parity data corresponding to the first authentication request; and
determining whether the second function block is authentic based on a result of the error correction decoding.

2. The method of claim 1, wherein the first function block is a memory controller and the second function block is a nonvolatile memory device, and
wherein the generating of the first authentication response comprises reading data from a memory cell at an address corresponding to the first authentication request after programming the memory cell at the address by applying a voltage to the memory cell at the address, and using the read data as the first authentication response.

3. The method of claim 2, further comprising searching for the first parity data in a first table stored in the memory controller.

4. The method of claim 2, further comprising receiving the first parity data, via the memory controller, from a source external the memory system.

5. The method of claim 2, wherein the nonvolatile memory device is determined to be authentic via the memory controller when the error correction decoding succeeds.

6. The method of claim 2, further comprising:
generating second parity data by performing an error correction encoding on the first authentication response; and
transmitting the second parity data and the first authentication response from the nonvolatile memory device to the memory controller,
wherein the performing of the error correction decoding is performed after performing an error correction decoding on the first authentication response by using the second parity data.

7. The method of claim 2, further comprising generating the first authentication request including at least two sub-authentication requests,
wherein the generating of the first authentication response comprises:
generating sub-authentication responses corresponding respectively to the at least two sub-authentication requests selected from sub-authentication requests set in the memory system; and
combining the sub-authentication responses corresponding respectively to the at least two sub-authentication requests to generate the first authentication response.

8. The method of claim 7, wherein the number of sub-authentication requests set in the memory system corresponds to a size of a space used to store authentication data in a memory cell array of the nonvolatile memory, and a size of the sub-authentication response.

9. The method of claim 8, wherein when the size of the space is N and the size of the sub-authentication response is R, a number of authentication request-response pairs is C, and
when the number of sub-authentication requests included in the first authentication request is K, the number of authentication request-response pairs that can be used in the memory system is a number of methods of selecting K from C,
wherein N, R, and K are positive integers, R is less than or equal to N, and C is N/R.

10. The method of claim 7, wherein the combining of the sub-authentication responses to generate the first authentication response comprises combining the sub-authentication responses corresponding respectively to the at least two sub-authentication requests in a random sequence by using at least one selected from a pseudo random number generator (PRNG) and an advanced encryption standard (AES).

11. The method of claim 1, wherein the first function block is a nonvolatile memory device and the second function block is a memory controller, and
wherein the generating of the first authentication response comprises:
searching for the first parity data corresponding to the first authentication request in a first table by using the memory controller; and
transmitting the first authentication response corresponding to the first authentication request and the first parity data from the memory controller to the nonvolatile memory device.

12. The method of claim 11, wherein the performing of the error correction decoding comprises performing an error correction decoding on the first authentication response, via the nonvolatile memory device, by using the first parity data received from the memory controller.

13. The method of claim 12, wherein the memory controller is determined to be authentic, via the memory device, when the error correction decoding succeeds.

14. The method of claim 1, wherein at least one of the first and second function blocks is a NAND flash memory device.

15. A method of operating a memory device, the method comprising:
generating a plurality of authentication responses in response to a combined authentication request obtained by combining at least two authentication requests, the plurality of authentication responses indicating physical characteristics of the memory device;
outputting the authentication responses, which form pairs respectively with the at least two authentication requests included in the combined authentication request, as a combined authentication response for the combined authentication request; and
authenticating the memory device using the combined authentication.

16. The method of claim 15, wherein the authenticating comprises:
performing an error correction decoding on the output responses using parity data;
determining whether the memory device is authentic based on a result of the decoding.

17. A method of authenticating a memory, the method comprising:
sending, by a memory controller, a challenge to the memory;
performing, by the memory controller, an error correction decoding on a response received from the memory due to the challenge using parity data;
determining, by the memory controller, the memory to be authentic when a result of the decoding indicates a successful decoding; and
determining, by the memory controller, the memory not to be authentic when the result indicates the decoding has failed.

18. The method of claim 17, wherein the memory comprises a three-dimensional memory array.

19. The method of claim 17, wherein prior to error correction decoding, the method includes using the challenge as an index into a table to retrieve the parity data.

20. The method of claim 17, wherein the response indicates a physical characteristic of the memory.
